(19) United States
(12) Patent Application Publication
(10) Pub. No.: US 2020/0372248 A1
(43) Pub. Date: Nov. 26, 2020

(54) CERTIFICATE RECOGNITION METHOD AND APPARATUS, ELECTRONIC DEVICE, AND COMPUTER-READABLE STORAGE MEDIUM

(71) Applicant: BEIJING SENSETIME TECHNOLOGY DEVELOPMENT CO., LTD., Beijing (CN)

(72) Inventors: Dixin ZHENG, Beijing (CN); Xuebo LIU, Beijing (CN)

(21) Appl. No.: 16/991,533

(22) Filed: Aug. 12, 2020

Related U.S. Application Data
(63) Continuation of application No. PCT/CN2019/108209, filed on Sep. 26, 2019.

(30) Foreign Application Priority Data
Apr. 30, 2019 (CN) 201910362419.4

(51) Int. Cl. G06K 9/00

(52) U.S. Cl. CPC G06K 9/00463; G06K 2209/01; G06K 9/00469

(57) ABSTRACT

A certificate recognition method and apparatus, an electronic device, and a computer-readable storage medium are provided. The method includes: performing key point detection on a certificate image to obtain information of multiple key points of a certificate included in the certificate image, where the multiple key points include at least two boundary defining points of a first text area in the certificate, and the first text area includes multiple text lines corresponding to a first character type; and determining a text recognition result of the certificate on the basis of the information of the multiple key points.

### CROSS-REFERENCE TO RELATED APPLICATION

The present disclosure is a U.S. continuation application of International Application No. PCT/CN2019/108209, filed on Sep. 26, 2019, which claims priority to Chinese Patent Application No. 201910362419.4, filed with the Chinese Patent Office on Apr. 30, 2019. The contents of International Application No. PCT/CN2019/108209 and Chinese Patent Application No. 201910362419.4 are incorporated herein by reference in their entireties.

### BACKGROUND

Optical Character Recognition (OCR) technologies have been widely applied to recognition of various certificates, cards and bills. The existing OCR technologies have high recognition precision in recognition of common characters, while the recognition precision for characters of special types such as ethnic minority characters needs to be improved.

### SUMMARY

The present disclosure relates to computer vision technologies, and in particular, to a certificate recognition method and apparatus, an electronic device, and a computer-readable storage medium.

Embodiments of the present disclosure provide a certificate recognition technology.

A first aspect of the embodiments of the present disclosure provides a certificate recognition method, including:

performing key point detection on a certificate image to obtain information of multiple key points of a certificate included in the certificate image, where the multiple key points include at least two boundary defining points of a first text area in the certificate, and the first text area includes multiple text lines corresponding to a first character type; and

determining a text recognition result of the certificate based on the information of the multiple key points.

A second aspect of the embodiments of the present disclosure provides a certificate recognition apparatus, including:

a key point detection unit, configured to perform key point detection on a certificate image to obtain information of multiple key points of a certificate included in the certificate image, where the multiple key points include at least two boundary defining points of a first text area in the certificate, and the first text area includes multiple text lines corresponding to a first character type; and

a text recognition unit, configured to determine a text recognition result of the certificate based on the information of the multiple key points.

According to another aspect of the embodiments of the present disclosure, provided is the certificate recognition apparatus, including:

a key point detection unit, configured to perform key point detection on a certificate image to obtain information of multiple key points of a certificate included in the certificate image, where the multiple key points include the at least two boundary defining points of a first text area in the certificate, and the first text area includes the multiple text lines corresponding to a first character type; and

a text recognition unit, configured to determine a text recognition result of the certificate based on the information of the multiple key points.

According to still another aspect of the embodiments of the present disclosure, provided is an electronic device, including a processor, where the processor includes the certificate recognition apparatus according to any one of the foregoing embodiments.

According to yet another aspect of the embodiments of the present disclosure, provided is an electronic device, including: a memory configured to store executable instructions; and

a processor configured to communicate with the memory to execute the executable instructions so as to complete the operations of the certificate recognition method according to any one of the foregoing embodiments.

According to further another aspect of the embodiments of the present disclosure, provided is a computer-readable storage medium, configured to store computer-readable instructions, where when the instructions are executed, the operations of the certificate recognition method according to any one of the foregoing embodiments are executed.

According to yet another aspect of the embodiments of the present disclosure, provided is a computer program, including a computer-readable code, where when the computer-readable code runs in a device, a processor in the device executes instructions for implementing the certificate recognition method according to any one of the foregoing embodiments.

According to yet another aspect of the embodiments of the present disclosure, provided is another computer program product, configured to store computer-readable instructions, where when the instructions are executed, a computer executes operations of a face recognition method or a face recognition network training method in any one of the foregoing possible implementations.

The embodiments of the present disclosure further provide another certificate recognition method and apparatus, an electronic device, a computer-readable storage medium, and a computer program product. The method includes: performing key point detection on a certificate image to obtain information of multiple key points in the certificate image, where the multiple key points include at least two boundary defining points of a first text area in a certificate, and the first text area includes multiple text lines corresponding to a first character type; and determining a text recognition result of the certificate based on the information of the multiple key points.

The technical solutions of the present disclosure are further described in detail below with reference to the accompanying drawings and embodiments.

### BRIEF DESCRIPTION OF DRAWINGS

The accompanying drawings constituting a part of the specification describe embodiments of the present disclosure and are intended to explain the principles of the present disclosure together with the descriptions.

According to the following detailed descriptions, the present disclosure may be understood more clearly with reference to the accompanying drawings.

FIG. 1 is an exemplary diagram of an identity card suitable for a certificate recognition technology provided in embodiments of the present disclosure.

FIG. 2 is a schematic flowchart of a certificate recognition method provided in embodiments of the present disclosure.

FIG. 3 is another schematic flowchart of a certificate recognition method provided in embodiments of the present disclosure.

FIG. 4 is another schematic flowchart of a certificate recognition method provided in embodiments of the present disclosure.

FIG. 5 is still another schematic flowchart of a certificate recognition method provided in embodiments of the present disclosure.

FIG. 6 is yet another schematic flowchart of a certificate recognition method provided in embodiments of the present disclosure.

FIG. 7 is an exemplary application diagram of a certificate recognition method provided in embodiments of the present disclosure.

FIG. 8 is another exemplary application diagram of a certificate recognition method provided in embodiments of the present disclosure.

FIG. 9 is a schematic structural diagram of a certificate recognition apparatus provided in embodiments of the present disclosure.

FIG. 10 is an exemplary schematic structural diagram of an electronic device according to embodiments of the present disclosure.

### DETAILED DESCRIPTION

Based on the certificate recognition method and apparatus, the electronic device, and the computer-readable storage medium provided in the foregoing embodiments of the present disclosure, key point detection is performed on a certificate image to obtain information of multiple key points of a certificate included in the certificate image, where the multiple key points include at least two boundary defining points of a first text area in the certificate, and the first text area includes multiple text lines corresponding to a first character type; and a text recognition result of the certificate is determined based on the information of the multiple key points. By adding the at least two boundary defining points of the first text area, the recognition accuracy of text positions of the multiple lines in the first text area is improved, the negative influence of other character types on text recognition of the first character type is reduced, and the recognition accuracy of the content of the first character type in the certificate is improved.

Exemplary embodiments of the present disclosure are described in detail with reference to the accompany drawings now. It should be noted that, unless otherwise stated specifically, relative arrangement of the components and operations, the numerical expressions, and the values set forth in the embodiments are not intended to limit the scope of the present disclosure.

Meanwhile, it should be understood that, for ease of description, the size of each part shown in the accompanying drawings is not drawn in actual proportion.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

Embodiments of the present disclosure are mainly applied to identity card recognition, but may also be applied to recognition of other certificates or bills that have a fixed or partially fixed format. No limitation is made thereto in the embodiments of the present disclosure.

The existing OCR algorithm has high recognition precision for most identity cards such as Han Chinese identity card. However, recognition of a small part of identity cards such as ethnic minority identity card mainly encounters the following key problems.

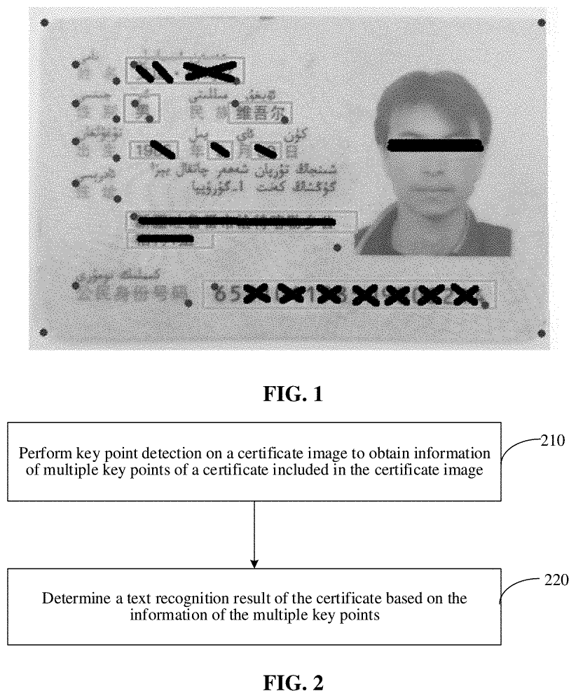

In addition to Chinese characters, the identity cards of common ethnic minorities, such as Mongols and Uyghurs, further include corresponding ethnic minority characters, for example, as shown in FIG. 1. An identity card recognition model used in the related art may not recognize ethnic minority characters. Therefore, the ethnic minority characters are recognized as messy codes during text recognition of ethnic minority identity cards. Furthermore, a lot of errors occur in Chinese character recognition due to the influence of the ethnic minority characters.

In addition, there are multiple formats for ethnic minority identity cards. Taking an address field as an example, there are two common formats at present, where in the first format type, ethnic minority characters and Chinese characters are not significantly different from each other in line spacing and appear line by line; and in the second format type, as shown in FIG. 1, although ethnic minority characters and Chinese characters appear in the same area, there is a significant difference in line spacing, and the ethnic minority characters and the Chinese characters do not appear line by line. The diversity in format also influences the accuracy of recognition of ethnic minority identity cards.

Regarding at least one of the foregoing problems, the embodiments of the present disclosure provide an image recognition technology. By adding the following defining points in key points as key points: at least two boundary defining points of a first text area including multiple text lines in a Chinese character area (such as points capable of determining the boundary of the first text area including a key point at the upper-left corner and a key point at the lower-right corner), the locating precision for the Chinese character area including at least the first text area is improved, and the influence of ethnic minority characters on Chinese character recognition is reduced, thereby facilitating improving certificate recognition precision.

FIG. 1 exemplarily shows 24 key points in embodiments of the present disclosure, including: key points at four top corners of a certificate image, key points at the upper-left corner and key points at the lower-right corner of a field name area (including: “Name”, “Gender”, “Date of Birth”, “Address”, and “Resident Identity Card Number”), and key points at the upper-left corner and key points at the lower-right corner of an information area of a field (including: an information area of a name field, an information area of a gender field, an information area of a nationality field, and an information area of an identity card number field) of some fields. In addition, a key point at the upper-left corner and a key point at the lower-right corner of an information area of an address field are also included. According to the embodiments of the present disclosure, the accuracy of Chinese character recognition for an ethnic minority identity card is improved by means of the key points at the upper-left corner and the key points at the lower-right corner of the information area of the address field.

It should be understood that the 24 key points shown in FIG. 1 are merely used for exemplification. The embodiments of the present disclosure may also use other number and types of key points. No limitation is made thereto in the embodiments of the present disclosure.

It should be understood that the technical solutions provided in the embodiments of the present disclosure are beneficial to recognition precision of ethnic minority identity cards, and are also applicable to recognition of Han Chinese identity cards or recognition of any similar certificate including at least two different character types. No limitation is made thereto in the embodiments of the present disclosure.

FIG. 2 is a schematic flowchart of a certificate recognition method provided in embodiments of the present disclosure.

At operation 210, key point detection is performed on a certificate image to obtain information of multiple key points of a certificate included in the certificate image.

In some embodiments, the certificate recognition method may be applied to various image processing devices, for example, the image processing devices include: terminal devices such as a mobile phone, a tablet computer, a wearable device, and an access control device.

In other embodiments, the certificate recognition method may be applied to a network side server, for example, a terminal collects one certificate image and uploads the certificate image to the server, and the server recognizes the certificate image to obtain certificate information of a certificate corresponding to the certificate image, the certificate information including at least a text recognition result.

For example, in a scene where a user is required to submit identity information for identity verification, the certificate recognition method according to the embodiments of the present application can still be used, where the user does not need to manually input the identity information and a certificate image can be conveniently collected; and then a terminal or server obtains a text recognition result in a certificate by recognizing the certificate image.

The multiple key points include at least two boundary defining points of a first text area in the certificate, and the first text area includes multiple text lines corresponding to a first character type.

The information of the multiple key points includes: positional information of the multiple key points in the certificate image.

The certificate image is an image formed by certificate collection. The certificate includes, but is not limited to, various certificate images including multiple types of characters such as an identity card, a passport, a residence permit, a temporary residence permit, a degree certificate, and an academic certificate.

The certificate includes two types of characters, i.e., the first character type and a second character type, where texts of the first character type and the second character type appear in different lines, where the text line of the first character type and the text line of the second character type may have the same or different contents.

In some embodiments, the first character type is a recognizable character type or a recognized target character type, such as Chinese character, and the second character type is an unrecognizable character type or a character type not to be recognized, such as character of an ethnic minority. For example, in an identity card recognition technology, in order to maintain the universality of the recognition technology and the applicability to recognition of Han Chinese identity cards and recognition of ethnic minority identity cards, Chinese characters in an identity card are recognized, but ethnic minority characters therein are not recognized.

In some embodiments, the first character type may be Chinese character, and the second character type may be a language used in another country or region, such as characters of a minority language of another country.

In the embodiments of the present disclosure, a text area corresponding to the first character type may only include text of the first character type, or may also further include character types other than the first and second character types, such as a number. Similarly, a text area corresponding to the second character type may include text of the second character type and text of other character types. No specific limitation is made thereto in the embodiments of the present disclosure.

In some optional embodiments, the certificate further includes a second text area, where the second text area includes at least one text line corresponding to the second character type different from the first character type, and the second text area and the first text area have the same text content. For example, as shown in FIG. 1, the information area of the address field in the identity card includes a Chinese character information area and an ethnic minority character information area, which represent the same address of a person. It is assumed that the first text area and the second text area are respectively the Chinese character information area and the ethnic minority character information area of the information area of the address field in the example shown in FIG. 1. The second text area and the first text area are adjacent or spaced by at least one blank line. However, the embodiments of the present disclosure are not limited thereto.

In the embodiments of the present disclosure, key point detection is performed on the certificate image to obtain the information of the multiple key points of the certificate included in the certificate image, where the information of the key points includes the positional information, or further includes other information. No limitation is made thereto in the embodiments of the present disclosure.

The multiple key points of the certificate include the at least two boundary defining points of the first text area, for example, the key points at the upper-left corner and the key points at the lower-right corner, or key points at the lower-left corner and key points at the upper-right corner, or four top points. No limitation is made thereto in the embodiments of the present disclosure.

By incorporating the at least two boundary defining points of the first text area corresponding to the first character type in the key points, the first text area can be precisely located, so that an accurate predicted line height of the first text area is obtained, the influence of the text of the second character type on the certificate recognition is reduced, and the recognition precision is improved.

At operation 220, the text recognition result of the certificate is determined based on the information of the multiple key points.

In some embodiments, a precise position of the text line included in the first text area can be determined based on the information of the multiple key points, and further, based on a text recognition method, the text of the first character type of which the position is determined is recognized to obtain the text recognition result of the first text area. In some embodiments, the position of the text line of the first character type in another text area included in the certificate can be further determined based on the position of the text line of the first character type included in the first text area, thereby facilitating improving the text recognition precision of the certificate.

Based on the certificate recognition method provided in the foregoing embodiments of the present disclosure, key point detection is performed on a certificate image to obtain information of multiple key points of a certificate included in the certificate image, where the multiple key points include at least two boundary defining points of a first text area in the certificate, and the first text area includes multiple text lines corresponding to a first character type; and a text recognition result of the certificate is determined based on the information of the multiple key points. By adding the at least two boundary defining points of the first text area, the recognition accuracy of text positions of the multiple lines in the first text area is improved, the influence of other character types on text recognition of the first character type is reduced, and the recognition accuracy of the content of the first character type in the certificate is improved.

In a certificate for an ethnic minority, the first character type is Chinese character, and the second character type is ethnic minority character.

The existing character recognition technology still cannot achieve recognition of ethnic minority characters. Therefore, the embodiments of the present disclosure need to exclude the interference of the ethnic minority characters on Chinese character contents, for example, when the ethnic minority characters and the Chinese characters do not appear line by line, i.e., there is a spacing between an ethnic minority character field and a Chinese character field, a conventional identity card processing method often fails to detect a text area, and erroneously takes the ethnic minority characters as the Chinese characters for detection and recognition, rendering an incorrect result.

In some embodiments, both the first text area and the second text area may be connected quadrilateral areas, such as a rectangular area.

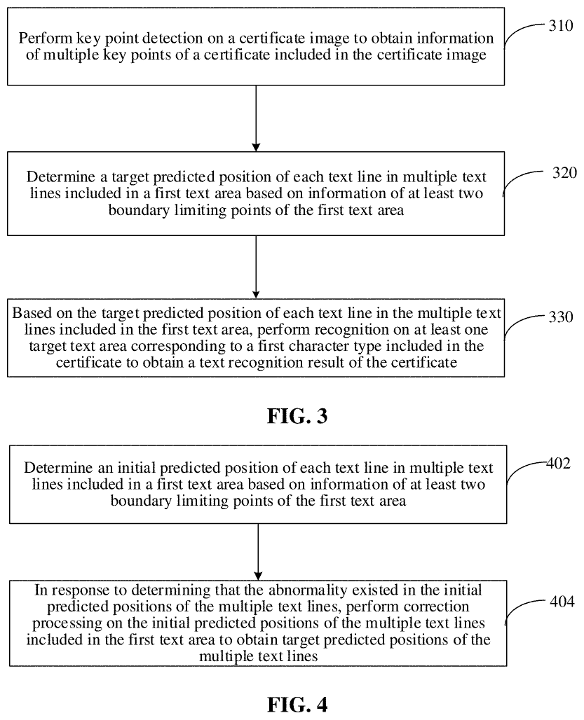

FIG. 3 is another schematic flowchart of a certificate recognition method provided in embodiments of the present disclosure.

At operation 310, key point detection is performed on a certificate image to obtain information of multiple key points of a certificate included in the certificate image.

The multiple key points include at least two boundary defining points of a first text area in the certificate, and the first text area includes multiple text lines corresponding to a first character type.

At operation 320, a target predicted position of each text line in the multiple text lines included in the first text area is determined based on the information of the at least two boundary defining points of the first text area.

In some embodiments, a rectangular area may be determined based on the information of the at least two boundary defining points of the first text area, where the rectangular area includes at least the first text area, and may further include part of a second text area. In order to perform recognition for the first character type in the first text area, the position of each text line needs to be determined, i.e., the target predicted position of each text line determined in the embodiments of the present disclosure, and then character recognition is performed at the target predicted position, so that the content of the first character type included in a first area may be determined. Recognition of the content in the first text area may be performed line by line. Line-by-line recognition improves the accuracy of character recognition, and reduces recognition errors caused by intersection between lines.

At operation 330, based on the target predicted position of each text line in the multiple text lines included in the first text area, recognition is performed on at least one target text area corresponding to the first character type included in the certificate to obtain a text recognition result of the certificate.

There are multiple types of certificates, a certificate may include multiple text areas of which the contents can be recognized (including the first text area), and all the character types in the text areas are the first character type. Furthermore, because the certificate is a special image having a fixed format, the line height of characters in the multiple text areas may be identical, for example, the heights of Chinese characters in an identity card are the same, i.e., the line heights of the Chinese characters in an identity card image are the same. Therefore, if the target predicted position of a text line included in the first text area is determined, the line height of the text line included in the first text area can also be determined; correction may be performed on the line heights of lines in the other text areas by means of the line height; and the position of each text line in the other text areas is determined according to the corrected line heights of the text lines, so as to determine the contents in the other text areas. The recognition accuracy of characters in the other text areas is improved.

FIG. 4 is a schematic diagram of partial flow in another embodiment of a certificate recognition method provided in embodiments of the present disclosure. Based on the foregoing embodiments, operation 320 includes the following operations.

At operation 402, an initial predicted position of each text line in the multiple text lines included in the first text area is determined based on the information of the at least two boundary defining points of the first text area.

In some embodiments, the initial predicted position of a text line may include an upper boundary and a lower boundary of the text line, and the position of the text line may be determined by means of coordinates of the upper and lower boundaries. The initial predicted position in the embodiments of the present disclosure may be determined based on the number of lines included in the first text area, an initial line height of each text line, and the upper boundary and the lower boundary of the first text area which are determined based on the information of the boundary defining points, where the number of lines and the initial line height may be obtained by using a neural network, for example, the number of lines included in the first text area and the initial line height of each text in the first text area in the certificate are recognized by using a deep neural network.

At operation 404, in response to determining that the abnormality existed in the initial predicted positions of the multiple text lines, correction processing is performed on the initial predicted positions of the multiple text lines included in the first text area to obtain the target predicted positions of the multiple text lines.

In order to improve the accuracy of content recognition, in the embodiments of the present disclosure, after the initial predicted position is obtained, it is necessary to determine whether the initial predicted position is normal, because if the initial predicted position is abnormal, recognition based on the initial predicted position causes an error of the recognized content. In the embodiments of the present disclosure, the accuracy of the text line position is improved by means of correction processing. The initial predicted positions of one or more text lines in the multiple text lines included in the first text area may be abnormal, and a correction process therefor may relate to performing correction on the abnormal initial predicted position based on the line heights of other text lines, and may also relate to performing correction on the initial predicted position based on other modes. The specific correction mode is not limited in the embodiments of the present disclosure.

After the initial predicted positions of the multiple text lines are obtained, whether an abnormality existed in the initial predicted positions of the multiple text lines can be determined.

Specifically, whether the initial positions of the multiple text lines are abnormal can be comprehensively determined. In some embodiments, whether the initial positions of the multiple text lines are abnormal is determined by determining whether a text line having an abnormal line height exists in the multiple text lines. For example, in response to the presence of a corresponding text line having an initial predicted line height greater than a first preset line height in the multiple text lines, it is determined that the abnormality existed in the initial predicted positions of the multiple text lines. For another example, in response to an average predicted line height of the multiple text lines being greater than a second preset line height, it is determined that the abnormality existed in the initial predicted positions of the multiple text lines, etc.

In some embodiments, the first preset line height may be obtained by means of collecting statistics about the text line heights in a large number of certificates, for example, the first preset line height is set to be 15 pixels.

In the embodiments of the present disclosure, whether to be greater than the first preset line height is taken as a determination standard for whether the initial predicted line height is normal. If the line height of each text line is less than or equal to the first preset line height, it indicates that the recognition result of the number of lines and the initial predicted line height is relatively accurate. In this case, in some embodiments, a first average line height is obtained based on the recognized upper boundary of the first text area and the recognized lower boundary of the first text area and the number of lines (or averaging the line heights of all lines), and the first average line height is taken as a target predicted line height of each text line, so as to determine the target predicted position of each text line. Moreover, in other embodiments, if there are one or more text lines in the multiple text lines having the initial predicted line heights greater than the first preset line height, it indicates that the recognition of the initial predicted line heights of the multiple text lines is wrong, and correction needs to be performed thereon, so as to improve the accuracy of the character recognition result.

In some embodiments, operation 404 includes: in response to determining that the abnormality existed in the initial predicted positions of the multiple text lines, determining a text line having an abnormal initial predicted line height in the first text area; in response to determining that the initial predicted line height of a first text line in the first text area is abnormal, performing correction on the initial predicted line height of the first text line to obtain a target predicted line height of the first text line; and performing correction on the initial predicted position of the first text line based on the target predicted line height of the first text line to obtain the target predicted position of the first text line.

Specifically, in the case that it is determined that the abnormality existed in the initial predicted positions of the multiple text lines, which text lines in the multiple text lines have the abnormal initial predicted positions are first determined, and then position correction is performed on the text lines of which the initial predicted positions are abnormal. Exemplarily, if it is detected that the initial predicted position of the first text line in the multiple text lines is abnormal, for example, the initial predicted line height is abnormal, correction on the predicted line height is performed for the first text line, so as to obtain the precise target predicted position.

In some embodiments, based on a first predicted average line height of the multiple text lines included in the first text area and the initial predicted line height of the first text line, a second predicted average line height of at least one second text line other than the first text line in the multiple text lines is determined, and correction is performed on the initial predicted line height of the first text line based on the second predicted average line height.

In some embodiments, the first predicted average line height of the first text area may be obtained based on positional information of the boundary defining points of the first text area and a predicted number of lines; then based on the first predicted average line height and the initial predicted line height of the first text line, an average predicted line height of the at least one second text line left in the first text area, i.e., the second average predicted line height, is obtained; and finally, correction may be performed on the initial predicted line height of the first text line based on the second average predicted line height to obtain the target predicted line height of the first text line.

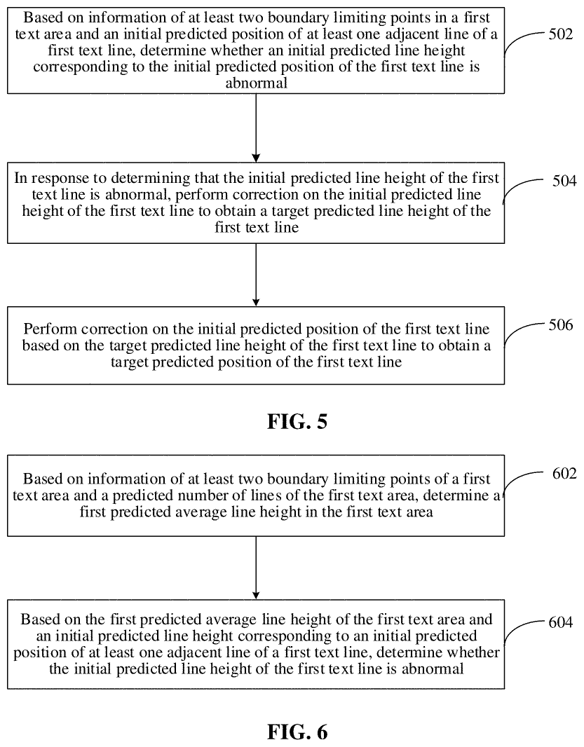

FIG. 5 is still another schematic flowchart of a certificate recognition method provided in embodiments of the present disclosure. Exemplarily, operation 404 includes the following operations.

At operation 502, based on the information of the at least two boundary defining points in the first text area and the initial predicted position of at least one adjacent line of the first text line, whether the initial predicted line height corresponding to the initial predicted position of the first text line is abnormal is determined.

The adjacent line may be the previous text line and/or a next text line of the first text line. When the first text line is the first line, the adjacent line is the next text line; when the first text line is a middle line, the adjacent line is the previous text line and the next text line; when the first text line is the last line, the adjacent line is the previous line. The line height of each text line in the multiple text lines included in the first text area should be the same. Therefore, when the difference between initial predicted line heights of the first text line and the adjacent line reaches a certain level, it indicates that the initial predicted line height of the first text line is abnormal.

At operation 504, in response to determining that the initial predicted line height of the first text line is abnormal, correction is performed on the initial predicted line height of the first text line to obtain the target predicted line height of the first text line.

In some embodiments, because the content in the second text area is the same as the content in the first text area, the second text area is generally adjacent to the first text area.

In order to reduce the influence of the second text area on the character content in the first text area, when the second text area is above the first text area, in the embodiments of the present disclosure, the position of the last line in the first text area generally does not need to be corrected. In this case, correction is performed on the initial predicted position of the first text line according to the next line of the first text line, and the correction of the text lines in the first text area proceeds from the first line to the second-to-last line. However, when the second text area is below the first text area, in the embodiments of the present disclosure, the position of the first line in the first text area generally does not need to be corrected. In this case, correction is performed on the initial predicted position of the first text line according to the previous line of the first text line, and the correction of the text lines in the first text area proceeds from the last line to the second line.

At operation 506, correction is performed on the initial predicted position of the first text line based on the target predicted line height of the first text line to obtain the target predicted position of the first text line.

In some embodiments, after the target predicted line height of the first text line is determined, the lower boundary is determined based on the determined upper boundary of the first text line, or the upper boundary is determined based on the determined lower boundary of the first text line, and the target predicted position is determined based on the upper boundary and the lower boundary.

In some embodiments, adjustment is performed on an initial predicted upper boundary of the first text line based on the target predicted line height of the first text line to obtain a target predicted upper boundary of the first text line.

After the target predicted line height of the first text line is determined, when the second text area is located above the first text area, it can be determined that wrong recognition may generally occur to the upper boundary. In this case, the upper boundary of the first text line may be determined based on an upper boundary of the next line. In some embodiments, the lower boundary of the first text line may intersect with the upper boundary of the next text line. In the embodiments of the present disclosure, correction may be performed on the lower boundary of the first text line to avoid the influence of characters of the next text line on the first text line. For example, the lower boundary of the first text line equals the upper boundary of the next text line minus 1 pixel. Optionally, the target predicted upper boundary of the first text line equals the lower boundary of the first text line minus the target predicted line height.

In the embodiments of the present disclosure, correction is performed on the initial predicted line height of the first text line by means of the initial predicted position of the adjacent line, and then the target predicted position is determined based on the corrected target predicted line height, so that the obtained line height and position relationships of the multiple text lines included in the first text area are more accurate, and the accuracy of the content recognition in the first text area is improved.

FIG. 6 is yet another schematic flowchart of a certificate recognition method provided in embodiments of the present disclosure. Exemplarily, operation 502 includes the following operations.

At operation 602, based on the information of the at least two boundary defining points of the first text area and the predicted numbers of lines of the first text area, the first predicted average line height of the multiple text lines in the first text area is determined.

For example, the at least two boundary defining points include key points at the upper-left corner and key points at the lower-right corner; an upper boundary coordinate of the first text area are determined based on the key points at the upper-left corner in the first text area; a lower boundary coordinate of the first text area are determined based on the key points at the lower-right corner; the height of the first text area can be determined by means of subtraction between the upper boundary coordinate and the lower boundary coordinate; and the predicted number of lines included in the first text area is recognized based on the neural network. In this case, the first predicted average line height may be determined according to a case where the height of the first text is within the predicted number of lines.

At operation 604, based on at least one of the first predicted average line height of the multiple text lines in the first text area and an initial predicted line height corresponding to an initial predicted position of at least one adjacent line of the first text line, whether the initial predicted line height of the first text line is abnormal is determined. For example, based on the first predicted average line height of the first text area and the initial predicted line height corresponding to the initial predicted position of at least one adjacent line of the first text line, whether the initial predicted line height of the first text line is abnormal is determined.

In the embodiments of the present disclosure, the first predicted average line height may be used for measuring the line heights of all text lines in the first text area. When the number of lines is accurately predicted, whether the initial predicted line height is abnormal is determined based on a relationship between the initial predicted line height of the first text line and the first predicted average line height, for example, the initial predicted line height of the first text line is greater than a set multiple of the first predicted average line height. However, the number of lines may be inaccurately predicted in the recognition process. Therefore, in the embodiments of the present disclosure, based on the first predicted average line height, the initial predicted position of the adjacent line is added as a basis for evaluating whether the initial predicted line height of the first text line is abnormal, so that the accuracy of determining whether the initial predicted line height is abnormal is improved.

For example, in some embodiments, operation 604 includes: in response to the initial predicted line height of the first text line reaching a first preset multiple of the first predicted average line height, determining that the initial predicted line height of the first text line is abnormal, or, in response to the initial predicted line height of the first text line reaching a second preset multiple of the initial predicted line height of the at least one adjacent line of the first text line, determining that the initial predicted line height of the first text line is abnormal, or, in response to the initial predicted line height of the first text line reaching the first preset multiple of the first predicted average line height and the initial predicted line height of the first text line reaching the second preset multiple of the initial predicted line height of the at least one adjacent line of the first text line, determining that the initial predicted line height of the first text line is abnormal. In this case, the first preset multiple and the second preset multiple may be the same or different, for example, the first preset multiple and the second preset multiple are set as 1.2 and the like. In the embodiments of the present disclosure, no limitation is made to the specific values of the first preset multiple and the second preset multiple.

For another example, in some embodiments, operation 604 includes: in response to the initial predicted line height of the first text line reaching the first preset multiple of the first predicted average line height, and the initial predicted line height of the first text line reaching the second preset multiple of the initial predicted line height of a next text line of the first text line, determining that the initial predicted line height of the first text line is abnormal.

The embodiments of the present disclosure are intended for a case where the second text area is located above the first text area. In this case, the lower the text line is, the further the text line is away from the second text area that interferes with the text content, i.e., the initial predicted line height of the lower text line is relatively accurate. Therefore, in the embodiments of the present disclosure, abnormality confirmation is performed on the initial predicted line height of the first text line based on the initial predicted line height of the next text line, and thus the accuracy of abnormal situation confirmation is improved.

In some embodiments, operation 504 includes: based on the first predicted average line height and the initial predicted line height of the first text line, determining the second predicted average line height of text lines other than the first text line in the multiple text lines; and performing correction on the initial predicted line height of the first text line based on the second predicted average line height to obtain the target predicted line height of the first text line. In the embodiments of the present disclosure, it is determined, based on the first predicted average line height and the initial predicted line height of the next text line, that the initial predicted line height of the first text line is abnormal. In this case, it is considered that the initial predicted line heights of the other text lines (including the next text line) are relatively accurate. Therefore, the second predicted average line height is obtained by averaging the initial predicted line heights of the other text lines, and correction is performed on the initial predicted line height of the first text line according to the second predicted average line height, so that the target predicted line height of the first text line is closer to the line heights of the other text lines in the first text area. The accuracy of the target predicted line height of each text line in the first text area is improved.

In some embodiments, in response to the second predicted average line height exceeding a first preset value, the line height of the first text line is corrected as a second preset value. For example, in response to a corrected line height of the first text line being greater than or equal to the second preset value, the initial predicted line height corresponding to the initial predicted position of a next text line of the first text line is taken as the target predicted line height of the first text line.

In some other embodiments, in response to the second predicted average line height being less than or equal to the second preset value, the line height of the first text line is corrected as the second predicted average line height.

The line height of the first text line is theoretically equal to the second predicted average line height determined based on the line heights of the other lines after removing the line height of the first text line. If the second predicted average line height is greater than the first preset value, it indicates that the first text line detected in this case is not a line of the first text area in a real certificate, but a result of merging two lines as one line after false detection occurs. For example, assuming that the first text area of a real identity card has four lines, three lines are actually detected, and the line height of the middle line happens to be close to the first average line height, then the middle line is corrected based on the second line height initial predicted line heights of the first line and the third line. In this case, the line height of the first text line is set as the second preset value. If the second predicted average line height is less than or equal to the second preset value, the line height of the first text line is set as the second predicted average line height.

In some embodiments, after the target predicted line height of the first text line is determined, under a condition that the lower boundary of the first text line keeps unchanged, adjustment is performed on a predicted upper boundary corresponding to the initial predicted position of the first text line based on the target predicted line height of the first text line to obtain the target predicted upper boundary of the first text line.

In some embodiments, operation 604 includes:

in response to the initial predicted line height of the first text line reaching the second preset multiple of the initial predicted line heights of the previous text line and a next text line of the first text line, determining that the initial predicted line height of the first text line is abnormal;

obtaining the corrected line height of the first text line based on the initial predicted line heights of the previous text line and the next text line of the first text line.

In the embodiments of the present disclosure, the first text line is the middle line, and the text lines adjacent to the first text line include the previous text line and the next text line. When whether the initial predicted line height of the first text line is abnormal cannot be determined by means of the first predicted average line height and the initial predicted line height of the next text line provided in the foregoing embodiments, a possible situation is that the initial predicted line height of the first text line is close to the first predicted average line height, but is greater than the initial predicted line height of the next text line. In this case, whether the number of lines is inaccurately recognized may be confirmed by means of a relationship between the initial predicted line height of the first text line and the initial predicted line heights of the previous text line and the next text line, and two text lines are erroneously recognized as one first text line; when the initial predicted line height of the first text line reaches the second preset multiple of the initial predicted line heights of the previous text line and the next text line of the first text line (such as approximately two times, etc.), it may be confirmed that the number of lines is erroneously recognized, and in this case, correction is performed on the line height of the first text line by means of the initial predicted line heights of the previous text line and the next text line. The correction process includes:

obtaining a third predicted average line height by averaging the initial predicted line heights of the previous text line and the next text line of the first text line; and

taking the third predicted average line height as the target predicted line height of the first text line.

A formula of obtaining the target predicted line height may be: the target predicted line height equals (the height of the previous text line plus the height of the next text line)/2. In some embodiments, the correction process further includes: determining the upper boundary of the first text line based on the third average line height and the lower boundary of the first text line, i.e., the upper boundary of the first text line equals the lower boundary of the first text line minus the target predicted line height.

In some embodiments, after operation 504, the method further includes:

in response to the corrected line height of the first text line being greater than or equal to the second preset value, taking the initial predicted line height of a next text line of the first text line as the target predicted line height of the first text line; and/or

in response to the corrected line height of the first text line being less than a third preset value, taking the corrected line height of the first text line as the target predicted line height of the first text line.

In the foregoing embodiments, after the initial predicted line height of the first text line is corrected, there may be another situation, i.e., the corrected line height is still obviously greater than a standard line height. For example, the corrected line height provided in the embodiments of the present disclosure is greater than or equal to the second preset value (such as 22 pixels). In this case, it indicates that the line height of the first text line is still wrong. In the case that the first text line is not the first line, the initial predicted line height of the next text line is taken as the target predicted line height of the first text line; when the corrected line height is close to the standard line height, for example, the corrected line height in the embodiments of the present disclosure is less than the third preset value, the corrected line height is taken as the target predicted line height of the first text line.

In some embodiments, operation 330 includes: based on the target predicted line heights corresponding to the target predicted positions of the multiple text lines included in the first text area, performing correction on an initial predicted position of a third text area in the at least one target text area to obtain a target predicted position of the third text area; and obtaining a text recognition result of the third text area based on the target predicted position of the third text area.

In the embodiments of the present disclosure, the line height of each text line in the first text area is the corrected target predicted line height. In some embodiments, when the obtained initial predicted line height of the third text area (such as a name field in the identity card image) is abnormal (for example, being greater than a set line height or a difference with the set line height being greater than a preset value, etc.). In some embodiments, a third predicted average line height of the first text area is determined based on the target predicted line heights of the multiple text lines included in the first text area; and based on the third predicted average line height and an initial predicted line height corresponding to an initial predicted position of the third text area, correction is performed on the initial predicted position of the third text area to obtain a final predicted position of the third text area. In this example, the third predicted average line height of the first text area may be obtained by averaging the target predicted line heights of all the text lines of the first text area, and correction is performed on the line height of the third text area according to the average line height. In some embodiments, a correction method relates to replacing the line heights of the text lines in the third text area with the third predicted average line height.

In some embodiments, information of each line in text detection of the first text area is read out; if the line height of each line is normal and no abnormal height occurs, an average line height of the first text area is recorded, and correction is performed on the line heights of the text lines in the third text area. A correction rule may include: if the difference of subtracting the third predicted average line height of the first text area from the line heights of the text lines in the third text area is greater than 2 pixels, the line heights of the text lines in the third text area are corrected as the third predicted average line height of the first text area.

In some embodiments, the certificate includes an identity card; and/or the first text area includes an address area.

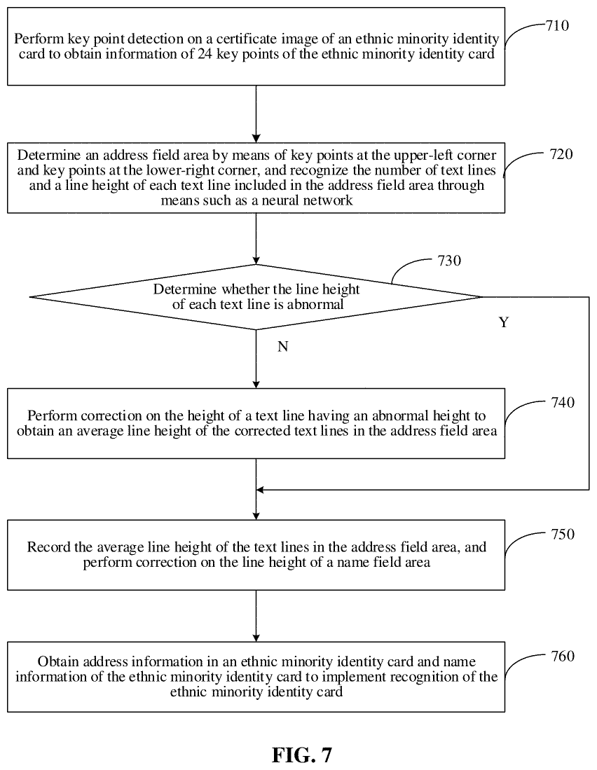

In one specific application example, the certificate recognition method provided in the embodiments is applied to recognition of an ethnic minority identity card. FIG. 7 is an exemplary application diagram of a certificate recognition method provided in embodiments of the present disclosure.

At operation 710, key point detection is performed on a certificate image of an ethnic minority identity card to obtain information of 24 key points in the ethnic minority identity card, where the 24 key points include key points at the upper-left corner and key points at the lower-right corner of an information area of an address field, and the information area of the address field includes multiple text lines of corresponding Chinese characters.

At operation 720, the information area of the address field is determined by means of the key points at the upper-left corner and the key points at the lower-right corner, and the number of text lines and the line height of each text line included in the information area of the address field are recognized through means such as a neural network.

At operation 730, whether the line height of each text line is normal is determined (for example, a difference with the line height of the identity card subjected to big data statistics collection is less than a set value); if the line height of each text line is normal, operation 750 is executed; and otherwise, operation 740 is executed.

At operation 740, if it is recognized that the number of text lines of the obtained information area of the address field is greater than or equal to 3, and the heights of one or more of text lines (generally one text line) are abnormal, correction is performed on the heights of the text lines having the abnormal heights, and a corrected average line height of the text lines in the information area of the address field is obtained. In some embodiments, because the ethnic minority characters are located above the Chinese characters, a correction method in this case only relates to performing correction on the first N−1 lines, and not performing correction on the last line, where N represents the number of text lines included in the information area of the address field.

At operation 750, an average line height avg_h_addr of the text lines in the information area of the address field is recorded, and correction is performed on a line height h_name of an information area of a name field. A correction rule is: if h_name-avg_h_addr>2 pixels, the line height h_name of the information area of the name field is corrected as the average line height avg_h_addr of an address field.

At operation 760, recognition is performed on Chinese character contents of each text line in the information area of the address field based on the average line height of the text lines in the information area of the address field to obtain address information in the ethnic minority identity card; and recognition is performed on Chinese character contents of the information area of the name field based on the corrected line height of the information area of the name field to obtain name information in the ethnic minority identity card, thereby achieving recognition of the ethnic minority identity card.

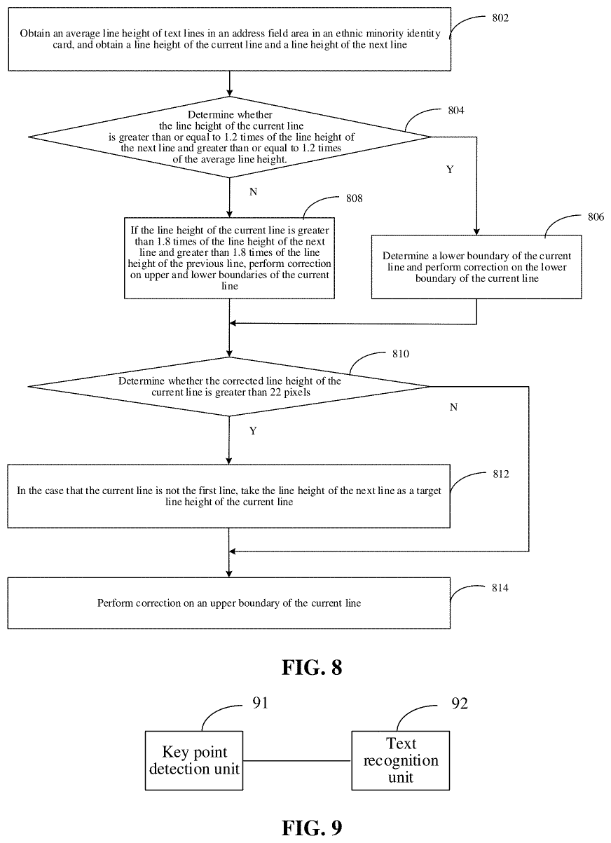

FIG. 8 is another exemplary application diagram of a certificate recognition method provided in embodiments of the present disclosure. Correction operations are sequentially performed on multiple text lines in the information area of the address field of the ethnic minority identity card from top to bottom (for example, from the first line to the (N−1)^{th} line) with the line height correction method provided in operation 740. In some embodiments, the correction process includes the following operations.

At operation 802, the average line height of the text lines in the information area of the address field of the ethnic minority identity card is calculated by means of upper and lower boundaries of a rectangular box where the information area of the address field is located and the number of lines; and the line height of the current line and the line height of the next line are detected.

At operation 804, whether the line height of the current line is greater than or equal to 1.2 times (where 1.2 is a set value and may be set according to different situations) of the line height of the next line, and greater than or equal to 1.2 times (where 1.2 is a set value and may be set according to different situations) of the average line height is determined; if it is a yes, it is determined that the line height of the current line is abnormal, and operation 806 is executed; and otherwise, operation 808 is executed.

At operation 806, a lower boundary of the current line is determined according to the recognition; if the lower boundary of the current line intersects with an upper boundary of the next line, correction is performed on the lower boundary of the current line, so as to avoid the influence of characters of the next line on the current line. In this case, the lower boundary of the current line equals the upper boundary of the next line minus 1 pixel. Then, correction is performed on the line height of the current line. The current height is theoretically equal to an average value new_h_avg_line of the line heights of other lines (e.g., all text lines other than the current line in the address field) after removing the line height of the current line. If new_h_avg_line is greater than 15 pixels (where 15 is an optional value and may be obtained by big data statistics collection), it indicates that the current line detected in this case is not really a line in the address field of the ethnic minority identity card, but a result of merging two lines as one line after false detection occurs. In this case, the line height of the current line is set as 15 pixels. If new_h_avg_line is less than or equal to 15 pixels, the line height of the current line is set as new_h_avg_line, a corrected line height of the current line is obtained, and operation 810 is executed.

At operation 808, when it is detected that the line height of the current line is close to the average line height (e.g., the line height of the current line is equal to a result of dividing the height of the information area of the address field by the number of lines), a height difference between the line height of the current line and the line height of each of two adjacent lines of the current line is determined; if the line height of the current line is greater than 1.8 times (where 1.8 is a set value and may be set according to different situations) of the line height of the next line and greater than 1.8 times of the line height of the previous line, correction is performed on the upper and lower boundaries of the current line. The correction formula is: the corrected line height of the current line equals (the line height of the previous line plus the line height of the next line)/2, and operation 810 is executed.

A situation where the operation is needed may correspond to a situation where there are four lines in the address field of the real ethnic minority identity card, and three lines are actually detected.

At operation 810, whether the corrected line height of the current line is greater than 22 pixels (where 22 is an optional value and may be obtained by big data statistics collection) is determined; if it is a yes, operation 812 is executed; and otherwise, the corrected line height of the current line is taken as a target line height of the current line, and operation 814 is executed.

At operation 812, in the case where the current line is not the first line, the line height of the next line is taken as the target line height of the current line, and operation 814 is executed. At operation 814, correction is performed on the upper boundary of the current line. The correction rule is: the upper boundary of the current line equals the lower boundary of the current line minus the target line height of the current line.

A person of ordinary skill in the art may understand that all or some operations for implementing the foregoing method embodiments may be achieved by a program by instructing related hardware; the foregoing program can be stored in a computer-readable storage medium; when the program is executed, operations including the foregoing method embodiments are executed. Moreover, the foregoing storage medium includes various media capable of storing program codes, such as a Read-Only Memory (ROM), a Random Access Memory (RAM), a magnetic disk, or an optical disk.

FIG. 9 is a schematic structural diagram of a certificate recognition apparatus provided in embodiments of the present disclosure. The apparatus can be used for implementing the foregoing method embodiments of the present disclosure. As shown in FIG. 9, the apparatus includes:

a key point detection unit 91, configured to perform key point detection on a certificate image to obtain information of multiple key points of a certificate included in the certificate image, where

the multiple key points include at least two boundary defining points of a first text area in the certificate, and the first text area includes multiple text lines corresponding to a first character type; and

a text recognition unit 92, configured to determine a text recognition result of the certificate based on the information of the multiple key points.

Based on the certificate recognition apparatus provided in the embodiments of the present disclosure, the text recognition result of the certificate is determined based on the information of the multiple key points. By adding the at least two boundary defining points of the first text area, the recognition accuracy of text positions of the multiple lines in the first text area is improved, the influence on text recognition of other character types on the first character type is reduced, and the recognition accuracy of contents of the first character type in the certificate is improved.

In some embodiments, the certificate further includes a second text area, where the second text area includes at least one text line corresponding to a second character type different from the first character type, and the second text area and the first text area have the same text content.

In some embodiments, the first character type is Chinese character, and the second character type is ethnic minority character.

In one or more embodiments, the text recognition unit 92 includes:

a position prediction module, configured to determine a target predicted position of each text line in the multiple text lines included in the first text area based on information of the at least two boundary defining points of the first text area; and

a text recognition module, configured to, based on the target predicted position of each text line in the multiple text lines included in the first text area, perform recognition on at least one target text area corresponding to the first character type included in the certificate to obtain the text recognition result of the certificate.

In some embodiments, the position prediction module is configured to determine an initial predicted position of each text line in the multiple text lines included in the first text area based on the information of the at least two boundary defining points of the first text area; determine whether the abnormality existed in the initial predicted positions of the multiple text lines; and in response to determining that the abnormality existed in the initial predicted positions of the multiple text lines, perform correction processing on the initial predicted positions of the multiple text lines included in the first text area to obtain the target predicted positions of the multiple text lines.

In some embodiments, the position prediction module includes:

the position prediction module, configured to, in response to the presence of a corresponding text line having an initial predicted line height greater than a first preset line height in the multiple text lines, determine that the abnormality existed in the initial predicted positions of the multiple text lines.

In some embodiments, the position prediction module includes:

the position prediction module, configured to, in response to determining that the abnormality existed in the initial predicted positions of the multiple text lines, determine a text line having an abnormal initial predicted line height in the first text area; in response to determining that the initial predicted line height of a first text line in the first text area is abnormal, perform correction on the initial predicted line height of the first text line to obtain a target predicted line height of the first text line; and perform correction on the initial predicted position of the first text line based on the target predicted line height of the first text line to obtain the target predicted position of the first text line.

In some embodiments, the position prediction module is configured to, based on a first predicted average line height of the multiple text lines included in the first text area and the initial predicted line height of the first text line, determine a second predicted average line height of at least one second text line other than the first text line in the multiple text lines; and perform correction on the initial predicted line height of the first text line based on the second predicted average line height.

In some embodiments, the position prediction module is configured to, in response to the second predicted average line height exceeding a first preset value, correct the line height of the first text line as a second preset value; and/or in response to the second predicted average line height being less than or equal to the second preset value, correct the line height of the first text line as the second predicted average line height.

In some embodiments, the position prediction module is configured to perform correction on the initial predicted line height of the first text line to obtain a corrected line height of the first text line; and in response to the corrected line height of the first text line being greater than or equal to the second preset value, take an initial predicted line height corresponding to the initial predicted position of a next text line of the first text line as the target predicted line height of the first text line, and/or in response to the corrected line height of the first text line being less than a third preset value, take the corrected line height of the first text line as the target predicted line height of the first text line.

In some embodiments, the position prediction module is configured to perform adjustment on a predicted upper boundary corresponding to the initial predicted position of the first text line based on the target predicted line height of the first text line to obtain a target predicted upper boundary of the first text line.

In some embodiments, the position prediction module is configured to, based on at least one of the first predicted average line height of the multiple text lines in the first text area and an initial predicted line height corresponding to an initial predicted position of at least one adjacent line of the first text line, determine whether the initial predicted line height of the first text line is abnormal.

In some embodiments, the position prediction module is configured to, in response to the initial predicted line height of the first text line reaching a first preset multiple of the first predicted average line height,

and/or,

in response to the initial predicted line height of the first text line reaching a second preset multiple of the initial predicted line height of the at least one adjacent line of the first text line,

determine that the initial predicted line height of the first text line is abnormal.

In some embodiments, the position prediction module is further configured to, based on the information of the at least two boundary defining points of the first text area and a predicted number of lines of the first text area, determine the first predicted average line height of the multiple text lines in the first text area.

In some embodiments, the text recognition module is configured to, based on the target predicted line heights corresponding to the target predicted positions of the multiple text lines included in the first text area, perform correction on an initial predicted position of a third text area in the at least one target text area to obtain a target predicted position of the third text area; and obtain a text recognition result of the third text area based on the target predicted position of the third text area.

In some embodiments, the text recognition module is configured to determine a target predicted average line height of the multiple text lines in the first text area based on the target predicted line heights of the multiple text lines included in the first text area; and based on the target predicted average line height and an initial predicted line height corresponding to the initial predicted position of the third text line included in the third text area, perform correction on the initial predicted position of the third text line to obtain a final predicted position of the third text line.

In some embodiments, the certificate includes an identity card; and/or

the first text area includes an information area of an address field.

According to another aspect of the embodiments of the present disclosure, provided is an electronic device, including a processor, where the processor includes the certificate recognition apparatus according to any of the foregoing embodiments of the present disclosure.

According to another aspect of the embodiments of the present disclosure, provided is an electronic device, including: a memory, configured to store executable instructions; and

a processor, configured to communicate with the memory to execute the executable instructions to implement any of the foregoing embodiments of the certificate recognition method provided in the present disclosure.

According to another aspect of the embodiments of the present application, provided is a computer storage medium, configured to store computer-readable instructions, where when the instructions are executed by a processor, the processor implements any of the foregoing embodiments of the certificate recognition method provided in the present disclosure.

According to another aspect of the embodiments of the present disclosure, provided is a computer program, including a computer-readable code, where when the computer-readable code runs in a device, a processor in the device executes the certificate recognition method provided in the present disclosure.

According to yet another aspect of the embodiments of the present disclosure, provided is a computer program product, configured to store computer-readable instructions, where when the instructions are executed, a computer executes the certificate recognition method according to any of the foregoing possible implementations.

In one or more optional implementations, the embodiments of the present disclosure further provide a computer program product, configured to store computer-readable instructions, where when the instructions are executed, a computer executes the certificate recognition method according to any of the foregoing embodiments.

The computer program product is specifically implemented by means of hardware, software, or a combination thereof. In an optional example, the computer program product is specifically represented by a computer storage medium. In another optional example, the computer program product is specifically represented by a software product, such as a Software Development Kit (SDK).

The embodiments of the present disclosure further provide another certificate recognition method and a corresponding apparatus thereof, an electronic device, a computer-readable storage medium, a computer program, and a computer program product. The method includes: performing key point detection on a certificate image to obtain information of multiple key points of a certificate included in the certificate image, where the multiple key points include at least two boundary defining points of the first text area in the certificate, and the first text area includes multiple text lines corresponding to a first character type; and determining a text recognition result of the certificate based on the information of the multiple key points.

In some embodiments, a target tracking indication is specifically an invoking instruction. A first apparatus instructs, by means of invoking, a second apparatus to perform certificate recognition. Accordingly, in response to receiving the invoking instruction, the second apparatus performs operations and/or processes in any embodiment of the foregoing certificate recognition method.

It should be understood that the terms such as “first” and “second” in the embodiments of the present disclosure are only used for distinguishing, and shall not be understood as limitations to the embodiments of the present disclosure.

It should also be understood that, in the present disclosure, “multiple” may refer to two or more, and “at least one” may refer to one, two or more.

It should also be understood that, for any component, data or structure mentioned in the present disclosure, if there is no explicit limitation or no opposite motivation is provided in context, it is generally understood that the number of the component, data or structure is one or more.

It should also be understood that, the descriptions of the embodiments in the present disclosure focus on differences between the embodiments, and for same or similar parts in the embodiments, refer to these embodiments. For the purpose of brevity, details are not described again.

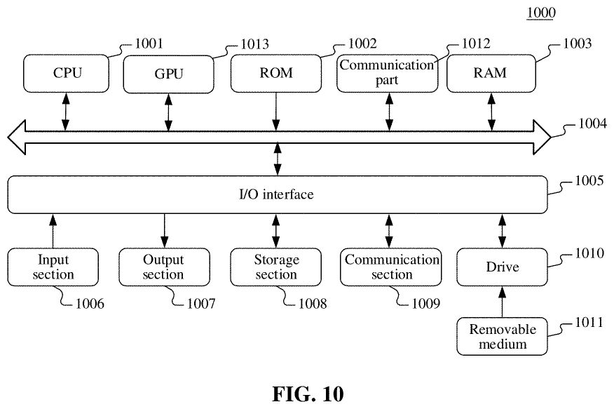

The embodiments of the present disclosure further provide an electronic device, which, for example, may be a mobile terminal, a Personal Computer (PC), a tablet computer, and a server. Referring to FIG. 10 below, a schematic structural diagram of an electronic device 1000, which is the terminal device or server suitable for implementing the embodiments of the present disclosure is shown. As shown in FIG. 10, the electronic device 1000 includes one or more processors, a communication part, or the like. The one or more processors are, for example, one or more Central Processing Units (CPUs) 1001 and/or one or more Graphic Processing Units (GPUs) 1013, and may execute appropriate actions and processings according to executable instructions stored in an ROM 1002 or executable instructions loaded from a storage section 1008 to an RAM 1003. The communication part 1012 may include, but is not limited to, a network card. The network card may include, but is not limited to, an Infiniband (IB) network card.

The processor communicates with the ROM 1002 and/or the RAM 1003 to execute the executable instructions, and is connected to the communication part 1012 by means of a bus 1004 and communicates with other target devices by means of the communication part 1012, so as to complete operations corresponding to any method provided in the embodiments of the present disclosure, for example, performing key point detection on a certificate image to obtain information of multiple key points of a certificate included in the certificate image, where the multiple key points include at least two boundary defining points of a first text area in the certificate, and the first text area includes multiple text lines corresponding to a first character type; and determining a text recognition result of the certificate based on the information of the multiple key points.

In addition, the RAM 1003 further stores various programs and data required for operations of an apparatus. The CPU 1001, the ROM 1002, and the RAM 1003 are connected to each other via the bus 1004. In the presence of the RAM 1003, the ROM 1002 is an optional module. The RAM 1003 stores executable instructions, or writes the executable instructions into the ROM 1002 during running, where the executable instructions cause the processor 1001 to perform corresponding operations of the foregoing communication method. An Input/Output (I/O) interface 1005 is also connected to the bus 1004. The communication part 1012 may be integrated, or may be configured to have multiple sub-modules (for example, multiple IB network cards) connected to the bus.

The following components are connected to the I/O interface 1005: an input section 1006 including a keyboard, a mouse and the like; an output section 1007 including a Cathode-Ray Tube (CRT), a Liquid Crystal Display (LCD), a speaker and the like; a storage section 1008 including a hard disk and the like; and a communication section 1009 of a network interface card including an LAN card, a modem and the like. The communication section 1009 performs communication processing via a network such as the Internet. A drive 1010 is also connected to the I/O interface 1005 according to requirements. A removable medium 1011 such as a magnetic disk, an optical disk, a magneto-optical disk, and a semiconductor memory is installed on the drive 1010 according to requirements, so that a computer program read from the removable medium is installed on the storage section 1008 according to requirements.

It should be noted that the architecture illustrated in FIG. 10 is merely an optional implementation mode. During specific practice, the number and types of the components in FIG. 10 may be selected, decreased, increased, or replaced according to actual requirements. Different functional components may be separated or integrated or the like. For example, the GPU and the CPU may be separated, or the GPU may be integrated on the CPU, and the communication part may be separated from or integrated on the CPU or the GPU or the like. These alternative implementations all fall within the scope of protection of the present disclosure.

Particularly, a process described above with reference to a flowchart according to the embodiments of the present disclosure is implemented as a computer software program. For example, the embodiments of the present disclosure include a computer program product. The computer program product includes a computer program tangibly included in a machine-readable medium. The computer program includes program codes for implementing a method shown in the flowchart. The program codes include instructions for correspondingly implementing operations of the method provided in the embodiments of the present disclosure, such as performing key point detection on a certificate image to obtain information of multiple key points of a certificate indicated the certificate image, where the multiple key points include at least two boundary defining points of a first text area in the certificate, and the first text area includes multiple text lines corresponding to a first character type; and determining a text recognition result of the certificate based on the information of the multiple key points. In such embodiments, the computer program is downloaded and installed from the network by means of the communication section 1009, and/or is installed from the removable medium 1011. The computer program, when being executed by the CPU 1001, executes the foregoing functions defined in the method of the present disclosure.

The method and apparatus of the present disclosure are implemented in many manners. For example, the methods and apparatuses of the present disclosure are implemented by means of software, hardware, firmware, or any combination of software, hardware, and firmware. Unless otherwise specially stated, the foregoing sequences of operations of the method are merely for description, and are not intended to limit the operations of the methods of the present disclosure. In addition, in some embodiments, the present disclosure may also be implemented as programs recorded in a recording medium. The programs include machine-readable instructions for implementing the methods according to the present disclosure. Therefore, the present disclosure further covers a recording medium storing the programs for executing the method according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to make a person of ordinary skill in the art understand the present disclosure, so as to design various embodiments with various modifications applicable to particular use.

1. A certificate recognition method, comprising:
performing key point detection on a certificate image to obtain information of multiple key points of a certificate comprised in the certificate image, wherein the multiple key points comprise at least two boundary defining points of a first text area in the certificate, and the first text area comprises multiple text lines corresponding to a first character type; and
determining, based on the information of the multiple key points, a text recognition result of the certificate.

2. The method according to claim 1, wherein the certificate further comprises a second text area, wherein the second text area comprises at least one text line corresponding to a second character type different from the first character type, and the second text area and the first text area have a same text content.

3. The method according to claim 2, wherein the first character type is Chinese character, and the second character type is ethnic minority character.

4. The method according to claim 1, wherein determining, based on the information of the multiple key points, the text recognition result of the certificate comprises:
determining, based on information of the at least two boundary defining points of the first text area, a target predicted position of each text line in the multiple text lines comprised in the first text area; and
performing, based on the target predicted position of each text line in the multiple text lines comprised in the first text area, recognition on at least one target text area corresponding to the first character type comprised in the certificate to obtain the text recognition result of the certificate.

5. The method according to claim 4, wherein determining, based on information of the at least two boundary defining points of the first text area, the target predicted position of each text line in the multiple text lines comprised in the first text area comprises:
determining, based on the information of the at least two boundary defining points of the first text area, an initial predicted position of each text line in the multiple text lines comprised in the first text area;
determining whether an abnormality existed in initial predicted positions of the multiple text lines; and
in response to determining that the abnormality existed in the initial predicted positions of the multiple text lines, performing correction processing on the initial predicted positions of the multiple text lines comprised in the first text area to obtain target predicted positions of the multiple text lines.

6. The method according to claim 5, wherein determining whether the abnormality existed in the initial predicted positions of the multiple text lines comprises:
in response to a presence of a text line having an initial predicted line height greater than a first preset line height in the multiple text lines, determining that the abnormality existed in the initial predicted positions of the multiple text lines.

7. The method according to claim 5, wherein in response to determining that the abnormality existed in the initial predicted positions of the multiple text lines, performing correction processing on the initial predicted positions of the multiple text lines comprised in the first text area to obtain the target predicted positions of the multiple text lines comprises:
in response to determining that the abnormality existed in the initial predicted positions of the multiple text lines, determining a text line having an abnormal initial predicted line height in the first text area;
in response to determining that an initial predicted line height of a first text line in the first text area is abnormal, performing correction on the initial predicted line height of the first text line to obtain a target predicted line height of the first text line; and
performing, based on the target predicted line height of the first text line, correction on the initial predicted position of the first text line to obtain the target predicted position of the first text line.

8. The method according to claim 7, wherein performing correction on the initial predicted line height of the first text line to obtain the target predicted line height of the first text line comprises:
determining, based on a first predicted average line height of the multiple text lines comprised in the first text area and the initial predicted line height of the first text line, a second predicted average line height of at least one second text line other than the first text line in the multiple text lines; and
performing, based on the second predicted average line height, correction on the initial predicted line height of the first text line.

9. The method according to claim 8, wherein performing, based on the second predicted average line height, correction on the initial predicted line height of the first text line comprises at least one of the following:
in response to the second predicted average line height exceeding a first preset value, correcting the line height of the first text line as a second preset value; or
in response to the second predicted average line height being less than or equal to the second preset value, correcting the line height of the first text line as the second predicted average line height.

10. The method according to claim 7, wherein performing correction on the initial predicted line height of the first text line to obtain the target predicted line height of the first text line comprises:
performing correction on the initial predicted line height of the first text line to obtain a corrected line height of the first text line; and at least one of the following:
in response to the corrected line height of the first text line being greater than or equal to a second preset value, taking an initial predicted line height corresponding to an initial predicted position of a next text line of the first text line as the target predicted line height of the first text line, or
in response to the corrected line height of the first text line being less than a third preset value, taking the corrected line height of the first text line as the target predicted line height of the first text line.

11. The method according to claim 7, wherein performing correction on the initial predicted position of the first text line based on the target predicted line height of the first text line to obtain the target predicted position of the first text line comprises:
performing, based on the target predicted line height of the first text line, adjustment on a predicted upper boundary corresponding to the initial predicted position of the first text line to obtain a target predicted upper boundary of the first text line.

12. The method according to claim 7, wherein determining the text line having the abnormal initial predicted line height in the first text area comprises:
determining, based on at least one of a first predicted average line height of the multiple text lines in the first text area or an initial predicted line height corresponding to an initial predicted position of at least one adjacent line of the first text line, whether the initial predicted line height of the first text line is abnormal.

13. The method according to claim 12, wherein determining, based on at least one of the first predicted average line height in the first text area and the initial predicted line height corresponding to the initial predicted position of the at least one adjacent line of the first text line, whether the initial predicted line height of the first text line is abnormal comprises:
in response to the initial predicted line height of the first text line reaching a first preset multiple of the first predicted average line height,
and/or,
in response to the initial predicted line height of the first text line reaching a second preset multiple of the initial predicted line height of the at least one adjacent line of the first text line,
determining that the initial predicted line height of the first text line is abnormal.

14. The method according to claim 12, further comprising:
determining, based on the information of the at least two boundary defining points of the first text area and a predicted number of lines of the first text area, the first predicted average line height of the multiple text lines in the first text area.

15. The method according to claim 4, wherein performing, based on the target predicted position of each text line in the multiple text lines comprised in the first text area, recognition on at least one target text area corresponding to the first character type comprised in the certificate comprises:
performing, based on target predicted line heights corresponding to the target predicted positions of the multiple text lines comprised in the first text area, correction on an initial predicted position of a third text area in the at least one target text area to obtain the target predicted position of the third text area; and
obtaining, based on the target predicted position of the third text area, a text recognition result of the third text area.

16. The method according to claim 15, wherein performing, based on the target predicted line heights corresponding to the target predicted positions of the multiple text lines comprised in the first text area, correction on the initial predicted position of the third text area in the at least one target text area to obtain the target predicted position of the third text area comprises:
determining, based on the target predicted line heights of the multiple text lines comprised in the first text area, a target predicted average line height of the multiple text lines in the first text area; and
performing, based on the target predicted average line height and an initial predicted line height corresponding to an initial predicted position of a third text line comprised in the third text area, correction on the initial predicted position of the third text line to obtain a final predicted position of the third text line.

17. The method according to claim 1, wherein the certificate comprises an identity card; and/or
the first text area comprises an information area of an address field.

18. An electronic device, comprising:
a memory, configured to store executable instructions; and
a processor, configured to communicate with the memory to execute the executable instructions, wherein when the executable instructions are executed by the processor, the processor is configured to:
perform key point detection on a certificate image to obtain information of multiple key points of a certificate comprised in the certificate image, wherein the multiple key points comprise at least two boundary defining points of a first text area in the certificate, and the first text area comprises multiple text lines corresponding to a first character type; and
determine, based on the information of the multiple key points, a text recognition result of the certificate.

19. The electronic device according to claim 18, wherein the certificate further comprises a second text area, wherein the second text area comprises at least one text line corresponding to a second character type different from the first character type, and the second text area and the first text area have a same text content.

20. A computer-readable storage medium, configured to store computer-readable instructions, wherein when the instructions are executed, the following operations are executed:
performing key point detection on a certificate image to obtain information of multiple key points of a certificate comprised in the certificate image, wherein the multiple key points comprise at least two boundary defining points of a first text area in the certificate, and the first text area comprises multiple text lines corresponding to a first character type; and
determining, based on the information of the multiple key points, a text recognition result of the certificate.
